(19) United States
(12) Patent Application Publication
(10) Pub. No.: US 2015/0358396 A1
(43) Pub. Date: Dec. 10, 2015

(54) INFORMATION PRESENTATION DEVICE, INFORMATION DISTRIBUTION DEVICE, AND THE INFORMATION PRESENTATION METHOD

(71) Applicant: MITSUBISHI ELECTRIC CORPORATION, Chiyoda-ku, Tokyo (JP)

(72) Inventors: Shinji AKATSU, Tokyo (JP); Kiyoshi MATSUTANI, Tokyo (JP); Yasutaka KONISHI, Tokyo (JP); Atsushi MATSUMOTO, Tokyo (JP); Takuji MORIMOTO, Tokyo (JP)

(73) Assignee: MITSUBISHI ELECTRIC CORPORATION, Tokyo (JP)

(21) Appl. No.: 14/763,125

(22) PCT Filed: Apr. 30, 2013
(86) PCT No.: PCT/JP2013/062583

§ 371 Date: Jul. 23, 2015

(51) Int. Cl. H04L 29/08

(52) U.S. Cl. CPC H04L 67/10

(57) ABSTRACT

An information presentation device includes a device side communicator that communicates with an information distribution server that retrieves information corresponding to distribution request information from information to be distributed and performs a selection on the information retrieved thereby and distributes information selected thereby, an information inputter that inputs both the contents of a request for information that is desired to be distributed, and points specifying both a reward for provision of information corresponding to this request contents and a description of the selection, a request information setter that generates the distribution request information to which both the request contents and the points are set, and transmits the distribution request information to the information distribution server via the communicator, and an information presenter that receives, via the communicator, the information which the information distribution server selects according to the description.

### FIELD OF THE INVENTION

The present invention relates to an information presentation device that receives information distributed thereto in response to a user's request and presents the information to the user, and an information distribution device and an information presentation method that distribute information according to a user's request.

### BACKGROUND OF THE INVENTION

Conventionally, an information presentation device that acquires facility information distributed thereto by an information distribution server at an arbitrary time, and utilizes the facility information in a vehicle has been proposed. This information presentation device is mounted in the vehicle, and, for example, displays an icon showing the position of a facility and the category of the facility on the screen and displays additional information, such as the phone number of the facility, when this icon is pressed down.

Further, a vehicle-mounted device that performs writing and display of evaluation information about an evaluation of a facility is disclosed by patent reference 1. This vehicle-mounted device displays a screen having a content for urging the user to generate evaluation information when the vehicle makes a transition from an idle state to a start state, information when the vehicle makes a transition from an idle state to a start state, and the user writes evaluation information according to this screen. When displaying evaluation information provided by another user, the vehicle-mounted device acquires and displays evaluation information posted for a facility about which facility information has been browsed.

### RELATED ART DOCUMENT

### Patent Reference

Patent reference 1: Japanese Unexamined Patent Application Publication No. 2006-178228

### SUMMARY OF THE INVENTION

### Problems to be Solved by the Invention

In the conventional technology represented by patent reference 1, the quality and the amount of information changes according to the user who has written facility information such as evaluation information. Further, according to the invention described in patent reference 1, an information provider side cannot know what type of information a user desires, and whether or not to provide detailed information about a facility depends on how the information provider feels at that time. Therefore, a problem with the conventional technology is that the user cannot acquire his or her desired facility information in many cases.

The present invention is made in order to solve the above-mentioned problem, and it is therefore an object of the present invention to provide an information presentation device, an information distribution device, and an information presentation method that make it possible for the user to precisely acquire information having his or her desired content.

### Means for Solving the Problem

In accordance with the present invention, there is provided an information presentation device including: a communicator communicating with an information distribution device that retrieves information corresponding to distribution request information from information to be distributed, and that performs a selection on the information retrieved thereby and distributes information selected thereby; an information inputter inputting both contents of a request for information that is desired to be distributed, and points specifying both a reward for provision of information corresponding to this request contents and a description of the selection for the information distribution device; a request information setter generating the distribution request information to which both the contents of the request for information that is desired to be distributed and the points, which are inputted from the information inputter, are set, and transmitting the distribution request information to the information distribution device via the communicator; and an information presenter receiving, via the communicator, the information which the information distribution device selects according to the description specified by the points, and presenting the information to a user.

### Advantages of the Invention

According to the present invention, there is provided an advantage of being able to precisely acquire information having contents which the user desires.

### BRIEF DESCRIPTION OF THE FIGURES

FIG. 1 is a diagram showing an outline of an information presentation system in accordance with the present invention;

FIG. 2 is a block diagram showing the configurations of an information presentation device (vehicle-mounted device) and an information distribution device in accordance with Embodiment 1 of the present invention;

FIG. 3 is a diagram showing an example of the request information DB in Embodiment 1;

FIG. 4 is a block diagram showing the configurations of an information presentation device (mobile terminal) and an information distribution device in accordance with Embodiment 1;

FIG. 5 is a sequence diagram of an information presentation method in accordance with Embodiment 1;

FIG. 6 is a diagram showing an example (example 1) of a request information setting screen in Embodiment 1;

FIG. 7 is a diagram showing an example (example 2) of the request information setting screen in Embodiment 1;

FIG. 8 is a diagram showing an example (example 1) of a request information display screen in Embodiment 1;

FIG. 9 is a diagram showing an example (example 2) of the request information display screen in Embodiment 1;

FIG. 10 is a diagram showing an example (example 3) of the request information display screen in Embodiment 1;

FIG. 11 is a diagram showing an example of a post information setting screen in Embodiment 1;

FIG. 12 is a diagram showing an example of a distribution information display screen corresponding to distribution request information in Embodiment 1;

FIG. 13 is a block diagram showing another example of the configurations of the information presentation device and the information distribution device in accordance with Embodiment 1;

FIG. 14 is a block diagram showing the configuration of an information presentation system in accordance with Embodiment 2 of the present invention;

FIG. 15 is a diagram showing an example of a shop information setting screen in Embodiment 2;

FIG. 16 is a sequence diagram of an information presentation method in accordance with Embodiment 2;

FIG. 17 is a diagram showing an example of a shop information setting screen corresponding to distribution request information in Embodiment 2;

FIG. 18 is a block diagram showing the configuration of an information presentation system in accordance with Embodiment 3 of the present invention;

FIG. 19 is a diagram showing an example of a post information setting screen in Embodiment 3; and

FIG. 20 is a diagram showing another example of the configuration of the information presentation system in accordance with Embodiment 3.

### EMBODIMENTS OF THE INVENTION

Hereafter, in order to explain this invention in greater detail, the preferred embodiments of the present invention will be described with reference to the accompanying drawings.

### Embodiment 1

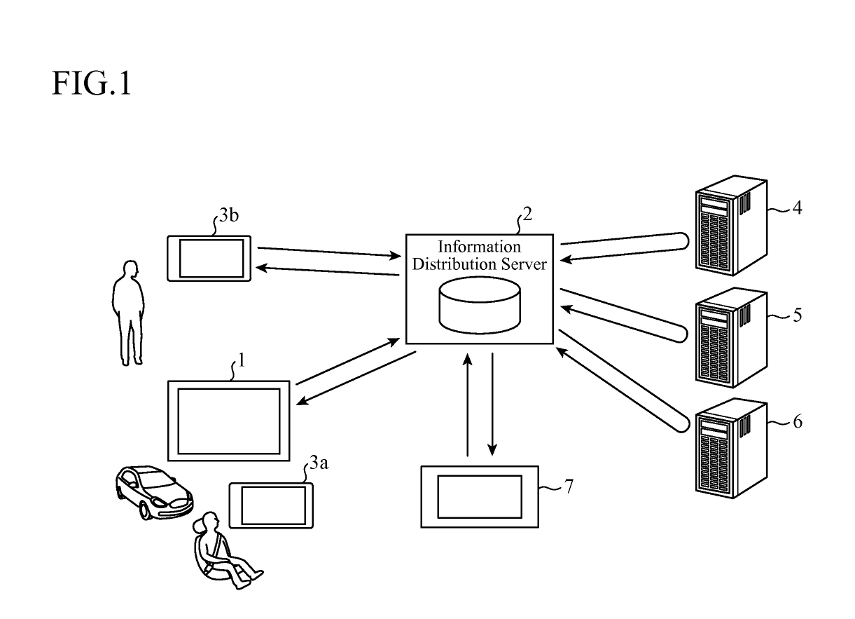

FIG. 1 is a diagram showing an outline of an information presentation system in accordance with the present invention. As shown in FIG. 1, the information presentation system in accordance with the present invention manages information including the evaluations of facilities posted by a plurality of users, and so on, and distributes information corresponding to a distribution request. For example, the information presentation system is configured to include a vehicle-mounted device 1, an information distribution server 2, mobile terminals 3a and 3b, Web servers 4 to 6, and a shop terminal 7. In this system, the information distribution server 2 is an information distribution device that stores information to be distributed in a storage and manages the information, and that retrieves information corresponding to distribution request information from the information to be distributed and distributes the information to either one of the vehicle-mounted device 1 and the mobile terminals 3a and 3b which is a request source.

The information distribution server 2 also performs a selection on the information retrieved from the storage according to the value of points set to the distribution request information, and distributes information selected thereby.

As a description of this selection, for example, there are a selection according to the amount of information of the information which is a result of the retrieval (information corresponding to the distribution request information), a selection according to the presence or absence of an image, and a selection according to a post time.

The points set to the distribution request information are purchased by a user who has registered with a data communications service provided by the information distribution server 2, or are provided as a reward for the post of effective information. The payment and reception of points for each user are managed by the information distribution server 2.

In this way, only more detailed information can be selected from the information corresponding to the request according to the value of the points paid by the side which will receive the information.

The information distribution server 2 can also retrieve information from external sites, respectively, managed by the Web servers 4 to 6 according to the value of the points set to the distribution request information.

As the external sites, there are a typical information retrieval site managed by the Web server 4, an SNS (Social Networking Service) managed by the Web server 5, and a content site, such as various users' blogs, managed by the Web server 6.

Thus, the retrieval range of the information corresponding to the request becomes widened according to the value of the points paid by the side which will receive the information, and the information corresponding to the request can be acquired from many sources.

The vehicle-mounted device 1 is an information presentation device that is mounted in a vehicle, and that receives the information corresponding to the distribution request information from the information distribution server 2 and presents the information to the user. For example, the vehicle-mounted device is implemented by a navigation device, a display audio device, or a vehicle-mounted display.

Each of the mobile terminals 3a and 3b is an information presentation device that receives the information corresponding to the distribution request information from the information distribution server 2, and presents the information to the user. For example, each of the mobile terminals is implemented by a smart phone, a mobile phone, a PHS (Personal Handy-phone System) phone, or a PDA (Personal Digital Assistant), a portable media player, a digital camera, a digital camcorder, or the like having a communication function.

Each of the vehicle-mounted device 1 and the mobile terminal 3a is an information presentation device mounted in a vehicle, and the mobile terminal 3b is an information presentation device carried by a pedestrian.

Further, each of the vehicle-mounted device 1 and the mobile terminals 3a and 3b can also serve as a poster terminal that generates post information to which information inputted from the user is set, and transmits the post information to the information distribution server 2.

A poster terminal receives call-for-post data to which distribution requests are set from the information distribution server 2, and presents the distribution requests on the basis of this call-for-post data.

For example, a call-for-post screen in which distribution requests are listed in descending order of the points set to the pieces of distribution request information is displayed, and posting of information corresponding to a distribution request is urged. In this way, according to the value of the points paid by the side which will receive the information, the degree of ease with which the information corresponding to the receive side's request is posted can be adjusted.

The shop terminal 7 is disposed in a facility, such as a shop, and serves as a poster terminal and posts information according to a distribution request. When a distribution request for information to which the shop terminal itself is set is made of the shop, the shop terminal 7 transmits advertisement information about the shop to the information distribution server 2 as post information for this distribution request. The information distribution server distributes the post information (advertisement information) received from the shop terminal 7 to the information presentation device (the vehicle-mounted device 1 or the mobile terminal 3a or 3b) which is the request source.

In this way, from a facility side, such as a shop, advertisement information for promoting the use of the facility can be distributed actively at a low cost.

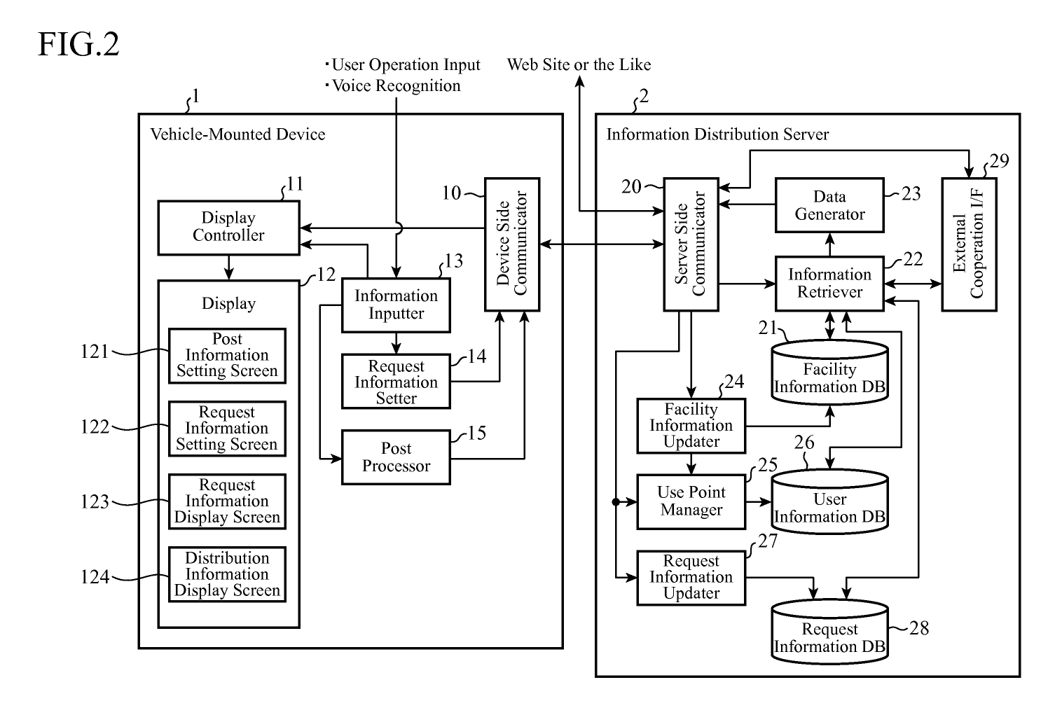

FIG. 2 is a block diagram showing the configuration of an information presentation device (vehicle-mounted device) and the information distribution device in accordance with Embodiment 1 of the present invention, and a case in which the information presentation device is the vehicle-mounted device 1.

The vehicle-mounted device 1 is mounted in a vehicle and functions as an information presentation device or a poster terminal, and is configured to include a device side communicator 10, a display controller 11, a display 12, an information inputter 13, a request information setter 14, and a post processor 15.

The device side communicator 10 is a communicator that communicates with the information distribution server 2. For example, the device side communicator performs HTTP (Hypertext Transfer Protocol) communications with the information distribution server 2 via a mobile network, such as 3G (3rd Generation) or LTE (Long Term Evolution).

The display controller 11 has a function of controlling a screen display of the display 12. For example, the display controller displays information which is distributed thereto from the information distribution server 2 in response to a distribution request on the screen of the display 12.

The display 12 is a display device that displays various pieces of information, and consists of a liquid crystal display, an organic EL (Electro-Luminescence) panel, or the like.

The display 12 also provides a UI (User Interface) for enabling the vehicle-mounted device 1 to generate post information or request information, and a UI for displaying request information or distribution information received from the information distribution server 2 under control by the display controller 11.

In the example shown in FIG. 2, the display displays a post information setting screen 121, a request information setting screen 122, a request information display screen 123, and a distribution information display screen 124.

The post information setting screen 121 is a setting screen for post information which is displayed on the display 12 under control by the display controller 11 when the vehicle-mounted device 1 generates post information. The request information setting screen 122 is a setting screen for distribution request information which is displayed on the display 12 under control by the display controller 11 when the vehicle-mounted device 1 generates distribution request information.

The request information display screen 123 is a display screen of a distribution request which is displayed on the display 12 under control by the display controller 11 when another user's distribution request is received from the information distribution server 2. The distribution information display screen 124 is a display screen of distribution information which is displayed on the display 12 under control by the display controller 11 when the distribution information is received from the information distribution server 2.

In this way, the display controller 11 and the display 12 function as an information presenter that presents the information received, via the device side communicator 10, from the information distribution server 2 and corresponding to the distribution request information to the user.

The information inputter 13 is a component with which the user performs an input of information, and accepts an input of information by way of a touch panel, hardware keys, a voice recognition, etc.

For example, while the display 12 displays the request information setting screen 122, the information inputter 13 accepts an input of both the contents of a request for information that is desired to be distributed, and points required to specify both a reward for provision of information corresponding to this request contents and the description of the selection for the information distribution server 2.

More specifically, in accordance with the present invention, as the points set to the distribution request information, the points of the reward provided for a poster who posts information which will be used by the vehicle-mounted device 1, and the points used for specifying the description of the selection which the information distribution server 2 will perform are set.

The request information setter 14 generates distribution request information to which the contents of the request for the information that is desired to be distributed and the points, which are inputted from the information inputter 13, are set, and transmits the distribution request information to the information distribution server 2 via the device side communicator 10.

As the contents of the request for the information that is desired to be distributed, for example, there are provided an area or a facility name associated with the information that is desired to be distributed, the time limit for distribution, the number of posters to whom the points which are the reward for provision of information are provided, and a request item.

In this case, a city, town or village, a regional name, or the like can be set as the area associated with the information that is desired to be distributed, and a facility name, such as a shop name, is set as the facility name associated with the information that is desired to be distributed.

Further, the time limit for distribution is the time limit to a period of time during which the information is desired to be distributed. In accordance with the present invention, the time limit for distribution of the information corresponding to the request can be set by the side which will receive the information.

The number of posters to whom the points are provided corresponds to the number of uses of distribution information. More specifically, if the current time does not exceed the time limit for distribution, pieces of distribution information whose number is equal to this number of posters can be used.

In a summary of the information that is desired to be distributed, what kind of information is desired is described concretely.

For example, there can be a case in which a question, such as “What is the instructor A's reputation in the 00 sports club?” is described.

The post processor 15 generates post information to which the information inputted from the information inputter 13 is set, and transmits the post information to the information distribution server 2 via the device side communicator 10.

For example, when call-for-post data in which the information distribution server 2 assigns priorities to distribution requests, respectively, in descending order of the points set to the pieces of distribution request information are received, the display 12 displays the distribution requests in the request information display screen 123 in the order of these priorities under control by the display controller 11.

When the user determines a distribution request on which the user will perform posting of information by using the information inputter 13 from the distribution requests displayed in this request information display screen 123, the display 12 displays the post information setting screen 121 under control by the display controller 11.

On the basis of this post information display screen 121, the user inputs information corresponding to the distribution request by using the information inputter 13. The post processor 15 generates post information to which the information inputted, in this way, from the information inputter 13 is set.

By causing a microcomputer of an information processing device in which the vehicle-mounted device 1 is configured to execute a program associated with the processing specific to the present invention, the device side communicator 10, the display controller 11, the display 12, the information inputter 13, the request information setter 14, and the post processor 15 are implemented as concrete units in each of which hardware and software operate in cooperation with each other.

The information distribution server 2 is an information distribution device that is connected to a network and distributes the information corresponding to the distribution request information, and is configured to include a server side communicator 20, a facility information DB (database) 21, an information retriever 22, a data generator 23, a facility information updater 24, a use point manager 25, a user information DB 26, a request information updater 27, a request information DB 28, and an external cooperation I/F 29.

The server side communicator 20 is a communicator that communicates with the vehicle-mounted device 1. For example, the server side communicator performs HTTP communications with the vehicle-mounted device 1.

The facility information DB 21 is an information database for distribution that stores pieces of information about facilities each of which is a distribution object. As the pieces of information about facilities, for example, pieces of facility information in each area, such as facility names for each facility genre, facility positions, and facility summaries, are listed. Further, pieces of information about events and sales each of which is posted from a facility side, each of the events and sales being performed during a limited period of time, discount coupons, and the rights of use of seats are also included.

Information, such as a discount coupon or the right of use of a seat, serves as onerous information which can be used according to the value of the points set to the distribution request information.

The information retriever 22 retrieves information corresponding to the distribution request information from the information to be distributed stored in the facility information DB 21 or the request information DB 28, and performs a selection on pieces of information which are retrieval results according to the description specified by the points in the distribution request information.

To the distribution request information, both the contents of the request for the information that is desired to be distributed, and the points for specifying both a reward for provision of information corresponding to this request contents and the description of the selection for the information distribution server 2 are set.

The data generator 23 has a function of generating distribution information by using the information which the information retriever 22 has selected. For example, the pieces of information which are the retrieval results provided by the information retriever 22 are sorted in descending order of registration times when the pieces of information were registered in the facility information DB 21, and are converted into ones in a data format, such as XML (Extensible Markup Language), HTML (HyperText Markup Language), or JSON (JavaScript (registered trademark) Object Notation). The distribution information generated by the data generator 23 is distributed to the vehicle-mounted device 1 via the server side communicator 20.

The facility information updater 24 updates the contents of the facility information DB 21 on the basis of information received from an external site via the server side communicator 20, and also notifies the users who will pay and receive points respectively according to the distribution request information to the use point manager 25.

The use point manager 25 manages the payment and reception of points provided for each user whose information is stored in the user information DB 26. For example, the use point manager 25 subtracts the points set to the distribution request information from the points of the user who has made the distribution request, and adds the points to another user who has posted the information (information presented by the vehicle-mounted device 1) which the former user has used on the basis of both the distribution request information acquired via the server side communicator 20, and the information which is notified from the facility information updater 24 and which shows the users who pay and receive the points respectively.

The user information DB (database) 26 stores the payment and reception of points for each user.

The request information updater 27 updates the contents of the request information DB 28 by using the distribution request information received by the server side communicator 20. For example, the request information updater 27 adds the distribution request information which the server side communicator 20 has received to the request information DB 28, and deletes distribution request information whose time limit for distribution has expired from the request information DB 28. The request information updater 27 also updates the contents of the request information DB 28 by using the post information for the distribution request which the server side communicator 20 has received. For example, the request information updater 27 adds, as information to be distributed, the post information corresponding to the distribution request which the server side communicator 20 has received to the request information DB 28.

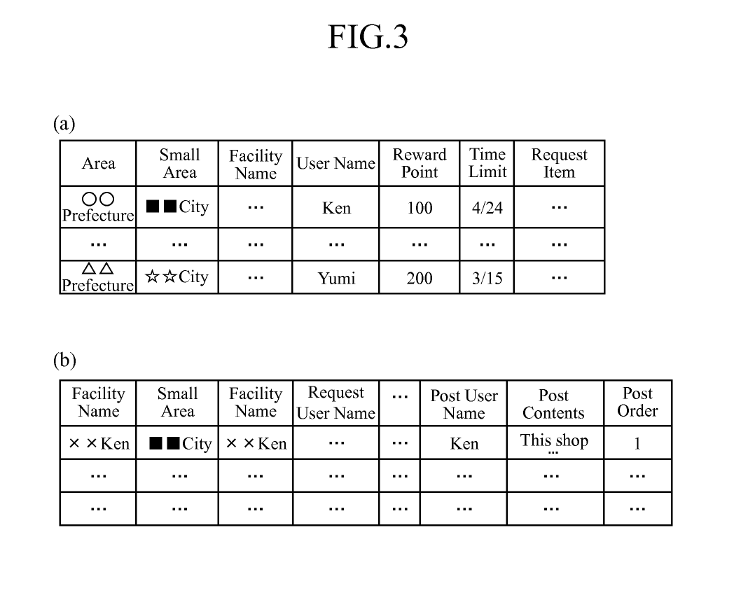

The request information DB (database) 28 is an information database for distribution that stores, as information to be distributed, both the distribution request information which the server side communicator 20 has received, and the post information corresponding to this distribution request information. For example, the request information DB is configured with table data, as shown in FIG. 3(a), in which items of each distribution request are set, and table data, as shown in FIG. 3(b), in which each distribution request is associated with post information corresponding to the distribution request. The items of each distribution request shown in FIG. 3(a) include an area, a facility name, a request source user's name, reward points, a time limit for distribution, and a request item which are associated with the information that is desired to be distributed. These pieces of information are extracted from each distribution request information by the request information updater 27.

Further, as the contents of each post information, in addition to a post user name and post contents, a posting order is set to the post information by the request information updater 27 in ascending order of its post time, as shown in FIG. 3(b).

The external cooperation I/F 29 is an external interface unit that communication-connects with an external site via the server side communicator 20. For example, when points in a distribution request registered in the request information DB 28 (points set to distribution request information) are equal to or greater than a predetermined threshold, the information retriever 22 retrieves information corresponding to the distribution request information from an external site by using the external cooperation I/F 29.

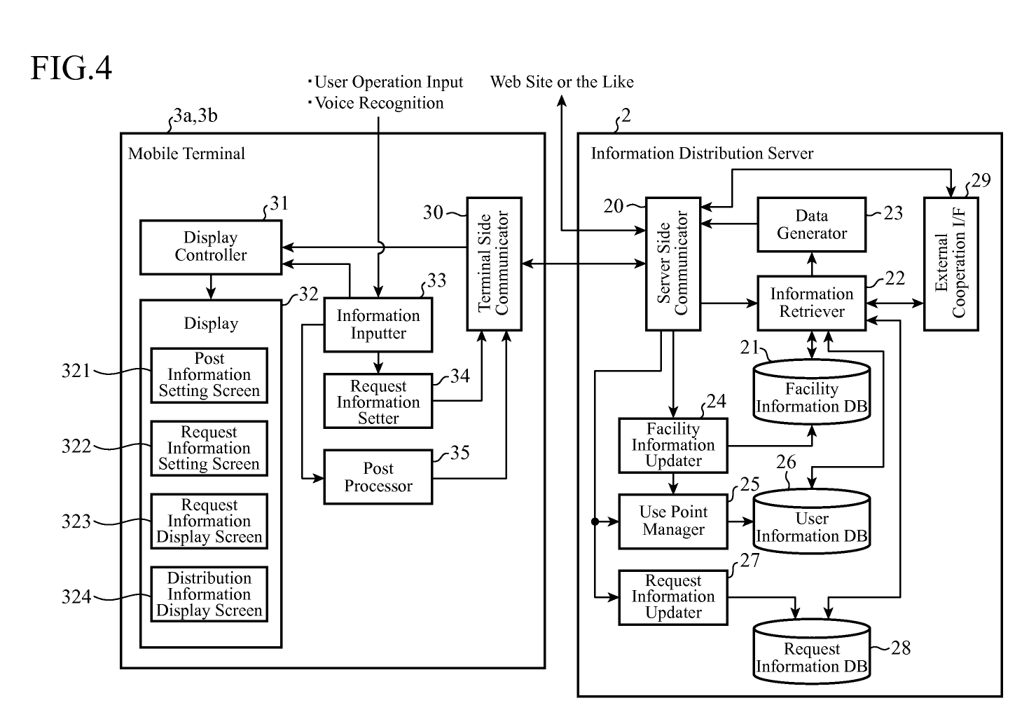

FIG. 4 is a block diagram showing the configuration of information presentation devices (mobile terminals) and the information distribution device in accordance with Embodiment 1, and shows a case in which the information presentation devices are the mobile terminals 3a and 3b.

Each of the mobile terminals 3a and 3b is a terminal, e.g., a portable navigation device or a tablet PC, which is carried by a user and which functions as an information presentation device or a poster terminal, and is configured to include a terminal side communicator 30, a display controller 31, a display 32, an information inputter 33, a request information setter 34, and a post processor 35.

Because the terminal side communicator 30, the display controller 31, the display 32, the information inputter 33, the request information setter 34, and the post processor 35 operate in the same way that the device side communicator 10, the display controller 11, the display 12, the information inputter 13, the request information setter 14, and the post processor 15 of the vehicle-mounted device 1 shown in FIG. 2 operate, respectively, the detailed explanation of the components will be omitted hereafter.

Further, by causing a microcomputer of an information processing device in which each of the mobile terminals 3a and 3b is configured to execute a program associated with the processing specific to the present invention, the terminal side communicator 30, the display controller 31, the display 32, the information inputter 33, the request information setter 34, and the post processor 35 are implemented as concrete units in each of which hardware and software operate in cooperation with each other.

Next, operations will be explained.

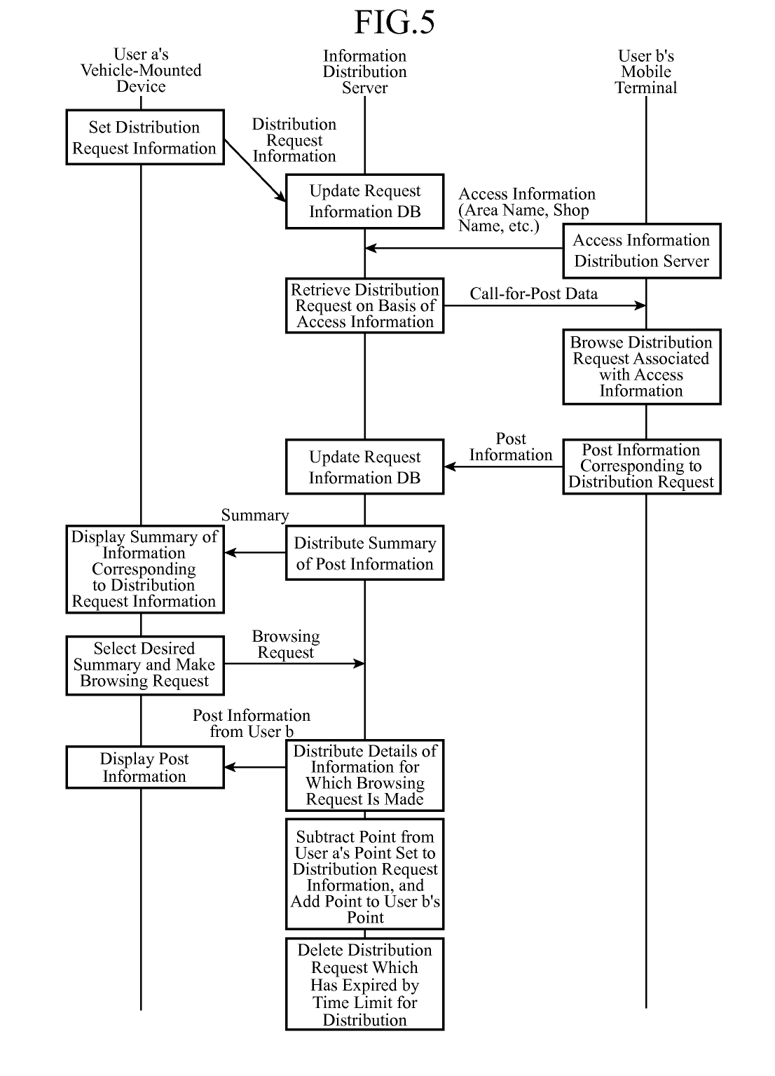

FIG. 5 is a sequence diagram of an information presentation method in accordance with Embodiment 1.

Hereafter, a case in which a user a's vehicle-mounted device 1 transmits distribution request information to the information distribution server 2, a user b's mobile terminal 3b posts information corresponding to the distribution request, and the vehicle-mounted device 1 browses this post information will be taken as an example.

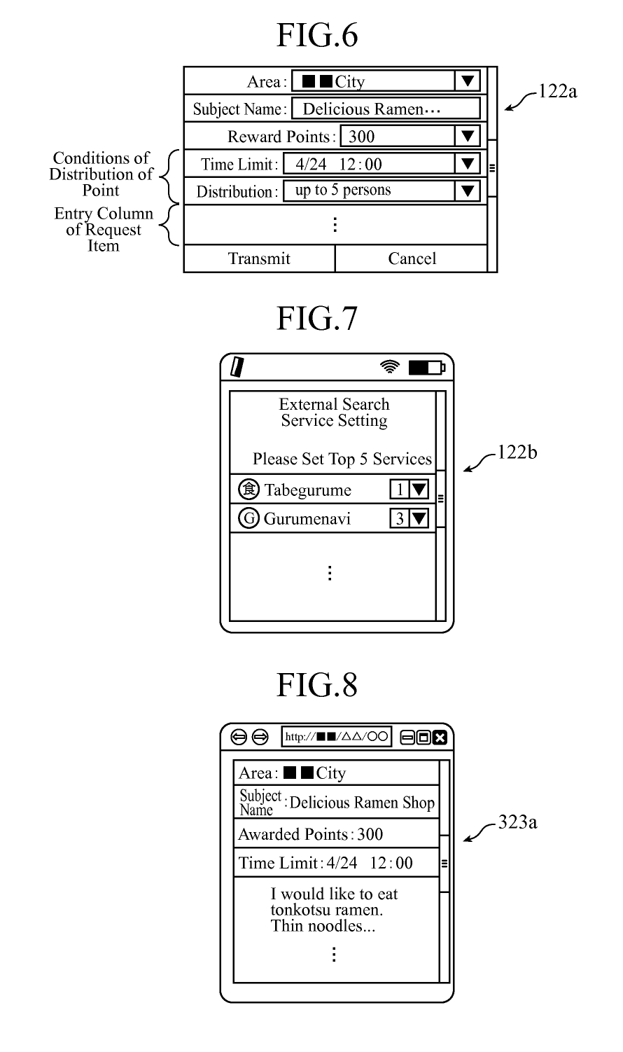

First, in the vehicle-mounted device 1, when the user a performs a request information setting operation by using the information inputting 13, the display controller 11 issues a command to display the request information setting screen 122 on the display 12. The display controller 11 displays the request information setting screen 122a as shown in FIG. 6 on the display 12 according to the command from the information inputter 13. The request information setting screen 122a is a screen for setting, as distribution request information, an area, a subject name of a request, reward points, a time limit for distribution, the number of posters to whom points serving as a reward for provision of information are provided, and a request item, which are associated with information that is desired to be distributed.

After that, the user a refers to the request information setting screen 122a, inputs an area, a subject name, a time limit for distribution, the number of posters, and a request item which are contents of a request for information that is desired to be distributed by using the information inputter 33, and further inputs points for specifying both a reward for provision of information corresponding to the request contents and a description of a selection for the information distribution server 2.

In the lower limit to reward points which can be set in the request information setting screen 122a, points of a reward for each post user, and points required for the information distribution server 2 to perform a selection according to minimum requirements are included. Further, by setting reward points having a higher value, the information distribution server 2 is made to select information having more substantial contents.

Further, when reward points equal to or greater than a first threshold are set in the request information setting screen 122a, a screen transition to the request information setting screen 122b as shown in FIG. 7 can be made.

The request information setting screen 122b is a screen for specifying external search services (external sites) with which the information distribution server 2 retrieves information corresponding to a distribution request.

Although a case in which the user a specifies top five external search services with which the user a desires the information distribution server 2 to perform retrieval on a priority basis is shown in FIG. 7, when reward points equal to or greater than a second threshold greater than the first threshold are set, the number of external search services (external sites) can be further increased.

The request information setter 14 generates distribution request information to which the contents of the request for the information that is desired to be distributed and the points, which are inputted from the information inputter 13 in the above-mentioned way, are set, and transmits the distribution request information to the information distribution server 2 via the device side communicator 10.

In the information distribution server 2, the request information updater 27 updates the contents of the request information DB 28 by using the user a's distribution request information received by the server side communicator 20. At that time, the request information updater 27 adds the distribution request information from the user a to the request information DB 28.

Next, in the user b's mobile terminal 3b, the terminal side communicator 30 accesses the information distribution server 2. At that time, the user b transmits, as access information, pieces of information which the user can post, such as the name of an area and the name of a shop, to the information distribution server 2.

The information retriever 22 of the information distribution server 2 searches through the request information DB 28 on the basis of the access information which the server side communicator 20 has received from the mobile terminal 3b, to extract distribution requests associated with the access information. After that, the data generator 23 generates call-for-post data in which priorities are assigned to the distribution requests extracted by the information retriever 22, respectively, in descending order of the points set to the pieces of distribution request information, and sends the call-for-post data to the mobile terminal 3b via the server side communicator 20.

Next, in the mobile terminal 3b, the display 32 displays the request information display screen 323, under control by the display controller 31, on the basis of the call-for-post data which the terminal side communicator 30 has received. Accordingly, the user b browses the distribution requests associated with the access information.

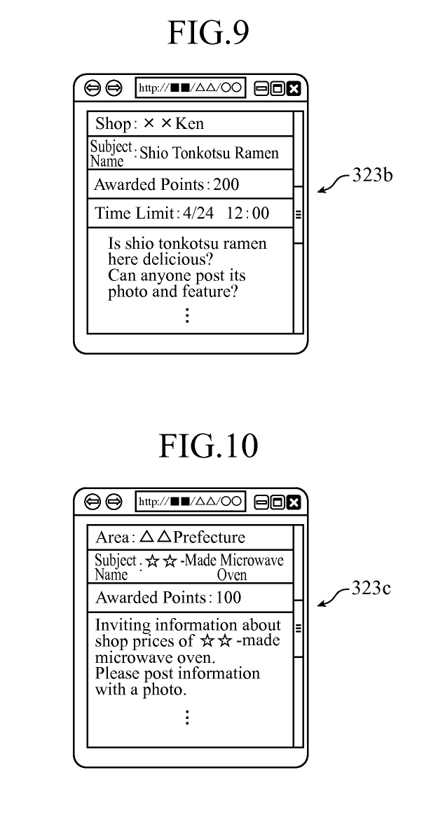

At that time, the display 32 displays the distribution requests in the order of the priorities set to the call-for-post data. For example, a request information display screen 323a shown in FIG. 8 is a one showing a distribution request whose value of reward points is “300” and is the largest, a request information display screen 323b shown in FIG. 9 is a one showing a distribution request whose value of reward points is “200”, and a request information display screen 323c shown in FIG. 10 is a one showing a distribution request whose value of reward points is the smallest and is “100.” Therefore, the display 32 displays the request information display screen 323a shown in FIG. 8, the request information display screen 323b shown in FIG. 9, and the request information display screen 323c shown in FIG. 10 in this order.

List data in which the distribution requests are displayed in descending order of the priorities can be displayed as a request information display screen. By doing in this way, post information can be collected more easily for the request made by a user who has paid higher reward points.

After that, the user b refers to the request information display screen 323, and inputs information for a distribution request by using the information inputter 33. For example, in the example of FIG. 11, a “post” button and a “cancel” button are placed in a lowermost end portion of the request information display screen 323a, and, when the “post” button is pressed down, the information inputter 33 notifies the display controller 31 that the “post” button is pressed down. When the “post” button is pressed down, the display controller 31 displays the post information setting screen 321 on the display 32.

Next, the user b refers to the post information setting screen 321, and describes information (comment field) corresponding to the distribution request by using the information inputter 33. At that time, the post processor 35 generates post information from the information inputted from the information inputter 33. After that, when the user b performs an operation of pressing down the “post” button in the post information setting screen 321, the post processor 35 transmits the post information to the information distribution server 2 via the terminal side communicator 30.

In the information distribution server 2, the request information updater 27 updates the contents of the request information DB 28 by using the post information received by the server side communicator 30. At that time, as shown in FIG. 3(b), the user b's post information is added, as post information for the user a's distribution request, to the request information DB 28. Further, when another post, other than the user b's post, is provided, each post information is brought into correspondence with the user a's distribution request in ascending order of the post time.

Next, the information retriever 22 retrieves post information corresponding to the user a's distribution request from the request information DB 28. At that time, when retrieving a plurality of pieces of post information, the information retriever 22 performs a selection on the pieces of post information which are retrieval results according to its description corresponding to the value of the points set to the distribution request information from the vehicle-mounted device 1. In this case, to the information retriever 22, the description of the selection which can be performed, such as (1) a selection according to the descending order of the amount of information in the comment field, (2) a selection of post information including an image, such as a photo, on a priority basis, and (3) a selection according to the ascending order of the post time, is set in advance, and at least one of the selections (1) to (3) is performed according to the value of the points set to the distribution request information.

For example, when the value of the points is less than the first threshold, the information retriever performs a selection according to only the description (3), when the value of the points is equal to or greater than the first threshold and is less than the second threshold greater than the first threshold, the information retriever performs a selection according to the descriptions (2) and (3), and, when the value of the points is equal to or greater than the second threshold, the information retriever performs a selection according to all the descriptions (1) to (3). The pieces of post information selected by the information retriever 22 are outputted to the data generator 23.

When receiving the pieces of post information from the information retriever 22, the data generator 23 generates distribution information in which summaries of the pieces of post information are listed, first. At that time, the pieces of post information are listed in the descending order in which the information retriever 22 has ranked the pieces of post information. The distribution information generated by the data generator 23 is transmitted, via the server side communicator 20, to the vehicle-mounted device 1 which is the request source.

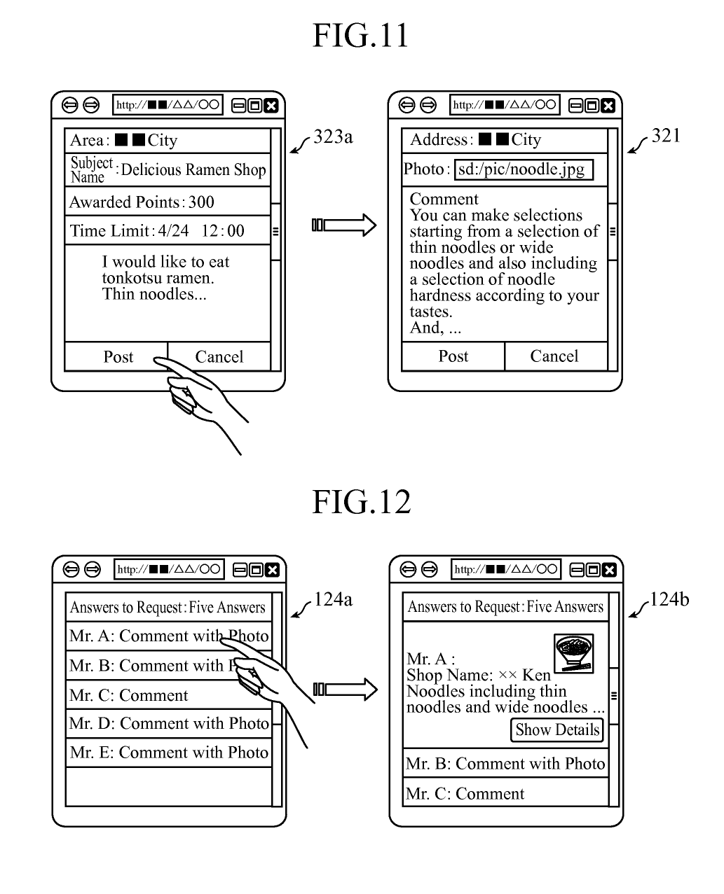

In the vehicle-mounted device 1, when receiving the summary data about the pieces of post information from the information distribution server 2 via the device side communicator 10, the display controller 11 displays a distribution information display screen 124a in which the summaries of the pieces of post information as shown in FIG. 12 are described on the display 12. In the example shown in FIG. 12, the summaries of the pieces of post information are listed in the descending order in which the information retriever 22 has ranked the pieces of post information. First, a minimum amount of information showing the summaries of the pieces of post information (post user names, comments, the presence or absence of a photo) is displayed.

The user a selects desired information from the summaries of the pieces of post information listed in the distribution information display screen 124a by using the information inputter 13. For example, because higher-order post information in the list in the distribution information display screen 124a is one selected by the information retriever 22 and having an abundant amount of information, the user a performs an operation of pressing down a post information column of “Mr. A” by using the information inputter 13. Information showing that the post information column of “Mr. A” is pressed down is notified from the information inputter 13 to the display controller 11.

When the post information column of “Mr. A” is pressed down, the display controller 11 changes the screen display of the display 12 to a distribution information display screen 124b, to show the post information of “Mr. A” which is more detailed than that in the distribution information display screen 124a. More specifically, the information distribution server 2 generates summary data for displaying the summaries of the pieces of post information in two levels. For example, as shown in FIG. 12, the names of the users who have posted the pieces of post information, comments, and data showing the presence or absence of a photo are listed in the distribution information display screen 124a which is displayed for the first time, and, when either one of the pieces of post information is selected, data showing the beginning portion of the comment of the post information (if there are images, a thumbnail of the images) is displayed as shown in the distribution information display screen 124b.

When the user a performs an operation of pressing down a “Show details” button in the distribution information display screen 124b by using the information inputter 13, the request information setter 14 makes a browsing request, via the device side communicator 10, of the information distribution server 2 for the details of the post information of “Mr. A.”

In the information distribution server 2, when receiving the browsing request for the detailed post information of “Mr. A”, the server side communicator 20 outputs the request to the information retriever 22 and the use point manager 25.

The information retriever 22 retrieves the post information of “Mr. A” for which the browsing request has been made from the request information DB 28, and outputs the post information to the data generator 23. The data generator 23 generates distribution information about the detailed contents of the post information of “Mr. A”, and transmits the distribution information, via the server side communicator 20, to the vehicle-mounted device 1 which is the request source.

In the vehicle-mounted device 1, the display controller 11 displays the distribution information about the detailed contents of the post information of “Mr. A”, which is received from the information distribution server 2 via the device side communicator 10, in the distribution information display screen 124 of the display 11. As a result, the user a can browse the detailed contents of the post information of “Mr. A.” By doing in this way, the vehicle-mounted device can precisely acquire the information having the contents which the user a desires.

On the other hand, in the information distribution server 2, the use point manager 25 subtracts the points (300 points) set to the distribution request information from the points of the user a who has performed the distribution request, the user a's points being stored in the user information DB 26, and adds the points (300 points) to the user b who has posted the information which the user a has used.

Further, the request information updater 27 monitors the time limit for distribution of each distribution request stored in the request information DB 28, and deletes distribution request information for which the time limit for distribution has expired from the request information DB 28.

Although the case of selecting and distributing post information in response to a distribution request in the above-mentioned sequence is shown, the information distribution server 2 can perform a selection on information which the information distribution server has retrieved and acquired from an external search service (external site) according to the value of the points set to the distribution request information, and distribute information selected thereby. Because there exists no post user to which points are added when the request source uses information retrieved from an external site, the request source user's points are consumed as a reward for the retrieval and provision of information by the information distribution server 2.

Although the case in which each of the vehicle-mounted device 1 and the mobile terminals 3a and 3b functions as an information presentation device is shown in FIGS. 2 and 4, the vehicle-mounted device and each of the mobile terminals can perform information presentation in cooperation with each other.

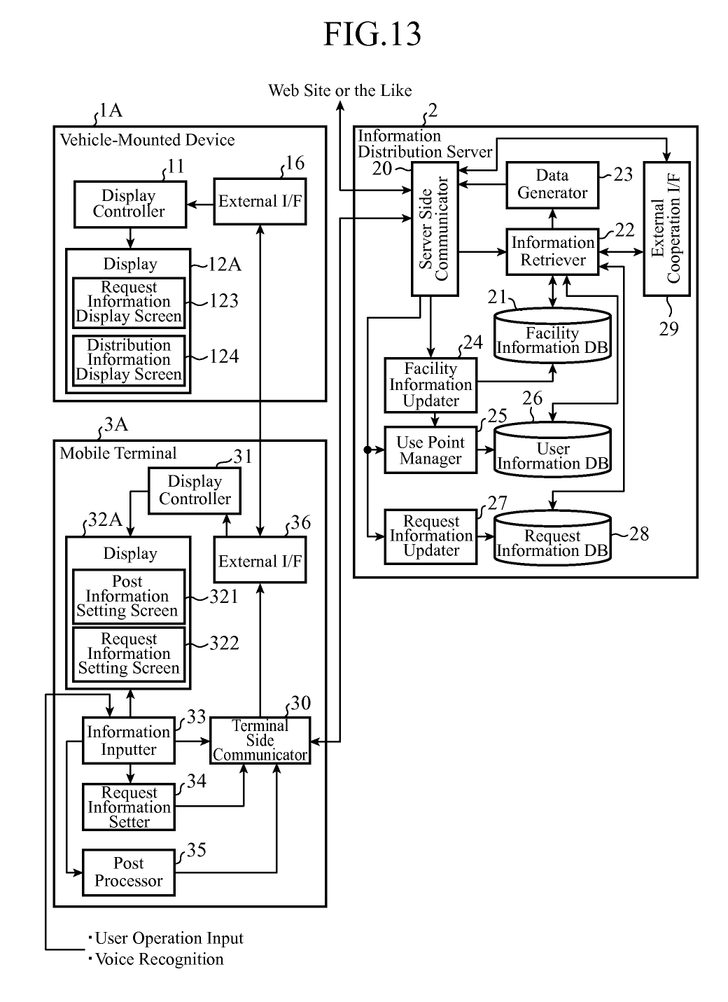

FIG. 13 is a block diagram showing another example of the configuration of an information presentation device and the information distribution device in accordance with Embodiment 1, and shows a case in which the vehicle-mounted device 1A and the mobile terminal 3A function as the information presentation device in cooperation with each other. As shown in FIG. 13, the vehicle-mounted device 1A is configured to include a display controller 11, a display 12, and an external I/F 16. Further, the mobile terminal 3A is configured to include a terminal side communicator 30, a display controller 31, a display 32A, an information inputter 33, a request information setter 34, a post processor 35, and an external I/F 36.

Each of the external I/Fs 16 and 36 is an interface that relays transmission and reception of information between the vehicle-mounted device 1A and the mobile terminal 3A.

In this configuration, the mobile terminal 3A displays a request information setting screen 322 on the display 32A, and accepts an input of both the contents of a request for information that is desired to be distributed, and points for specifying both a reward for provision of information corresponding to this request contents and a description of a selection for the information distribution server 2.

As a result, distribution request information which is generated on the basis of the inputted information is transmitted from the mobile terminal 3A to the information distribution server 2. The mobile terminal 3A receives distribution information which is distributed from the information distribution server 2 in response to this distribution request, and the distribution information is transmitted to the vehicle-mounted device 1A via the external I/F 36 and the external I/F 16. The vehicle-mounted device 1A displays the distribution information received from the mobile terminal 3A in a distribution information display screen of the display 12A. Even in the case in which the information presentation device and the information distribution device are configured in this way, information having contents which the user desires can be acquired precisely.

As mentioned above, in accordance with this Embodiment 1, each information presentation device includes the device side communicator 10 (or the terminal side communicator 30) that communicates with the information distribution server 2 that retrieves information corresponding to distribution request information from the information to be distributed, and performs a selection on the retrieved information and distributes information selected thereby, the information inputter 13 (or 33) that inputs both the contents of a request for information that is desired to be distributed, and points for specifying both a reward for provision of information corresponding to this request contents and a description of the selection for the information distribution server 2, the request information setter 14 (or 34) that generates distribution request information to which both the contents of the request for the information that is desired to be distributed and the points, which are inputted from the information inputter 13 (or 33), are set, and that transmits the distribution request information to the information distribution server 2 via the device side communicator 10 (or the terminal side communicator 30), and the information presenter that is configured with the display controller 11 (or 31) and the display 12 (or 32) that receive the information which the information distribution server 2 has selected according to the description specified by the points via the device side communicator 10 (or the terminal side communicator 30), and that present the information to the user. Because each information presentation device is configured in this way, the information distribution side further performs a selection on the information corresponding to the request according to the points paid by the side which will receive information, and distributes information selected thereby, and, as a result, information having contents which the user desires can be acquired precisely.

Further, in accordance with this Embodiment 1, the information inputter 13 (or 33) inputs the points for causing the information distribution server 2 to retrieve information corresponding to the distribution request information from an external site, and the request information setter 14 (or 34) generates distribution request information to which the points inputted from the information inputter 13 (or 33) are set. By doing in this way, the retrieval range of information corresponding to a request becomes widened according to the value of the points paid by the side which will receive the information, and the information corresponding to the request can be acquired from many sources.

In addition, in accordance with this Embodiment 1, the information inputter 13 (or 33) inputs the points for specifying the number of external sites on which the information distribution server 2 will perform retrieval for the information distribution server 2, and the request information setter 14 (or 34) generates distribution request information to which the points inputted from the information inputter 13 (or 33) are set. By also doing in this way, the retrieval range of information corresponding to a request becomes widened, and the information corresponding to the request can be acquired from many sources.

In addition, in accordance with this Embodiment 1, the information inputter 13 (or 33) inputs a specification of an external site on which the information distribution server 2 will perform retrieval, and the request information setter (or 34) generates distribution request information for specifying the external site inputted from the information inputter 13 (or 33) as a target for retrieval. By also doing in this way, the retrieval range of information corresponding to a request becomes widened, and the information corresponding to the request can be acquired from many sources.

In addition, in accordance with this Embodiment 1, the information inputter 13 (or 33) inputs, as a description of the selection, points specifying at least one of a selection according to the amount of information, a selection according to the presence or absence of an image, and a selection according to the post time for the information distribution server 2, and the request information setter 14 (or 34) generates distribution request information to which the points inputted from the information inputter 13 (or 33) are set. By doing in this way, information having contents which the user desires can be acquired precisely.

In addition, in accordance with this Embodiment 1, the information inputter 13 (or 33) inputs, as the contents of a request for information that is desired to be distributed, an area or a facility name associated with the information that is desired to be distributed, the time limit for distribution, the number of posters to whom the points which are the reward for provision of information are provided, and a request item, and the request information setter 14 (or 34) generates distribution request information to which the contents of the request for the information that is desired to be distributed, which are inputted from the information inputter 13 (or 33), are set. By doing in this way, information having contents which the user desires can be acquired precisely.

In addition, in accordance with this Embodiment 1, each information presentation device includes the post processor (or 35) that generates post information to which the information inputted from the information inputter 13 (or 33) is set, and transmits the post information to the information distribution server 2 via the device side communicator 10 (or the terminal side communicator 30). By configuring each information presentation device in this way, each of the vehicle-mounted device 1 and the mobile terminals 3a and 3b can be made to serve as both an information presentation device and a poster terminal.

In addition, in accordance with this Embodiment 1, when call-for-post data in which the information distribution server 2 assigns priorities to distribution requests of pieces of distribution request information, respectively, in descending order of the points set to the pieces of distribution request information are received by the device side communicator 10 (or the terminal side communicator 30), the information presenter that is configured with the display controller 11 (or 31) and the display 12 (or 32) presents the distribution requests to the user according to these priorities, the information inputter 13 (or 33) accepts an input of information corresponding to a distribution request, and the post processor 15 (or 35) generates post information to which the information inputted from the information inputter 13 (or 33) and corresponding to the distribution request is set and transmits the post information to the information distribution server 2 via the device side communicator 10 (or the terminal side communicator 30).

By configuring each information presentation device in this way, the post user can post information to a request having higher reward points, and the side which will receive the information can adjust the degree of ease with which the information corresponding to the receive side's request is posted according to the value of the points which the receive side sets to the distribution request.

### Embodiment 2

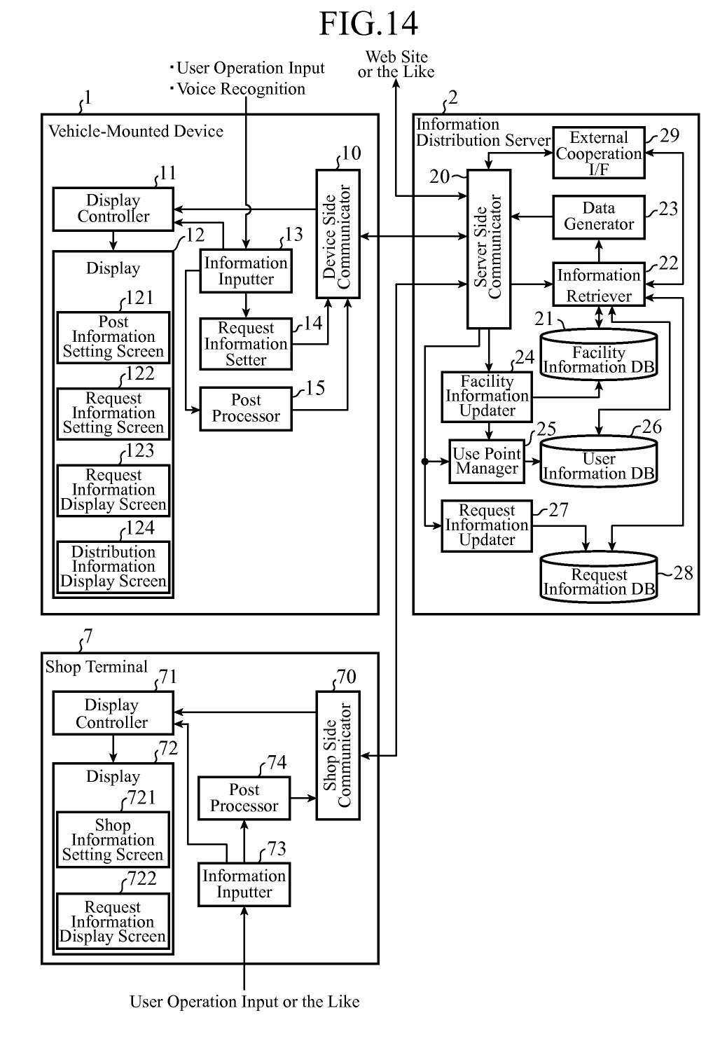

FIG. 14 is a block diagram showing the configuration of an information presentation system in accordance with Embodiment 2 of the present invention. Referring to FIG. 14, the information presentation system in accordance with Embodiment 2 is configured to include a vehicle-mounted device 1, an information distribution server 2, and a shop terminal 7. The shop terminal 7 is a facility terminal placed in a facility, such as a shop, and is configured to include a shop side communicator 70, a display controller 71, a display 72, an information inputter 73, and a post processor 74.

The shop side communicator 70 is a communicator that communicates with the information distribution server 2. For example, the shop side communicator performs HTTP communications with the information distribution server 2.

The display controller 71 has a function of controlling a screen display produced by the display 72. For example, the display controller displays information which is distributed from the information distribution server 2 in response to a distribution request on the screen of the display 72.

The display 72 is a display device that displays various pieces of information, and consists of a liquid crystal display or an organic EL panel. Further, the display 12 provides a UI for enabling the vehicle-mounted device 1 to generate post information or request information, and a UI for displaying request information or distribution information received from the information distribution server 2 under control by the display controller 71. In the example shown in FIG. 14, the display displays a shop information setting screen 721 and a request information display screen 722.

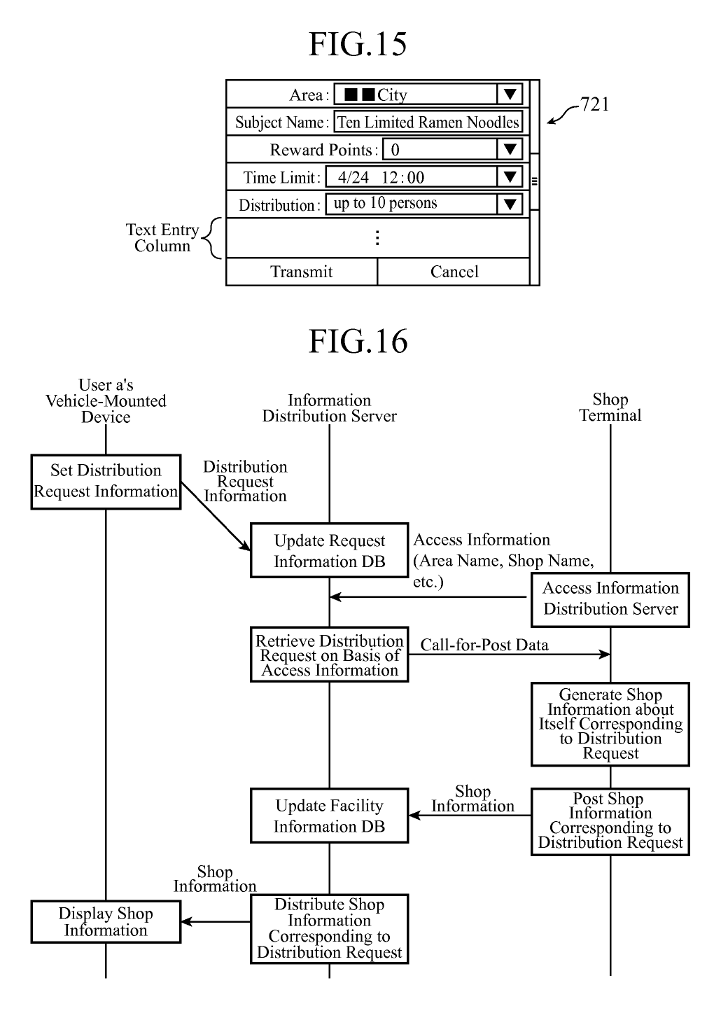

The shop information setting screen 721 is a setting screen for post information which is displayed on the display 72 under control by the display controller 71 when the shop terminal 7 generates post information. For example, as shown in FIG. 15, the shop information setting screen is a one for setting, as post information, an area associated with the post information, a subject name of the information, reward points, a time limit for distribution, the number of posters to whom the points which are a reward for provision of information are provided, and a post item (text entry column). Further, the request information display screen 722 is a display screen for distribution request which is displayed on the display 72 under control by the display controller 71 when another user's distribution request is received from the information distribution server 2.

Next, operations will be explained.

FIG. 16 is a sequence diagram of an information presentation method in accordance with Embodiment 2.

Hereafter, a case in which a user a's vehicle-mounted device 1 transmits distribution request information to the information distribution server 2, the shop terminal 7 posts information corresponding to the distribution request, and this post information is browsed by the vehicle-mounted device 1 will be taken as an example.

First, in the vehicle-mounted device 1, a request information setter 14 generates distribution request information to which both the contents of a request for information that is desired to be distributed and points, which are inputted from an information inputter 13, are set, and transmits the distribution request information to the information distribution server 2 via a device side communicator 10, like that in accordance with Embodiment 1.

In the information distribution server 2, a request information updater 27 updates the contents of a request information DE 28 by using the user a's distribution request information received by a server side communicator 20, like that in accordance with Embodiment 1. At that time, the request information updater 27 adds the distribution request information from the user a to the request information DE 28.

Next, in the shop terminal 7, the shop side communicator 70 accesses the information distribution server 2. At that time, the shop side communicator transmits the name of an area in which the shop itself is placed, the shop's name, etc., as access information, to the information distribution server 2. An information retriever 22 of the information distribution server 2 searches through the request information DE 28 on the basis of the access information which the server side communicator 20 has received from the shop terminal 7, to extract distribution requests associated with the access information. After that, a data generator 23 generates call-for-post data in which priorities are assigned to the distribution requests extracted by the information retriever 22, respectively, in descending order of the points set to the pieces of distribution request information, and sends the call-for-post data to the shop terminal 7 via the server side communicator 20.

Next, in the shop terminal 7, the display 72 displays the request information display screen 722 under control by the display controller 71 on the basis of the call-for-post data which the shop side communicator 70 has received. As a result, the user of the shop terminal 7 browses the distribution requests associated with the access information. At that time, the display 72 displays the distribution requests in the order of the priorities set to the call-for-post data. For example, the display displays list data in which the distribution requests are displayed in descending order of the priorities as the request information display screen. By doing in this way, post information can be collected more easily for the request made by a user who has paid higher reward points.

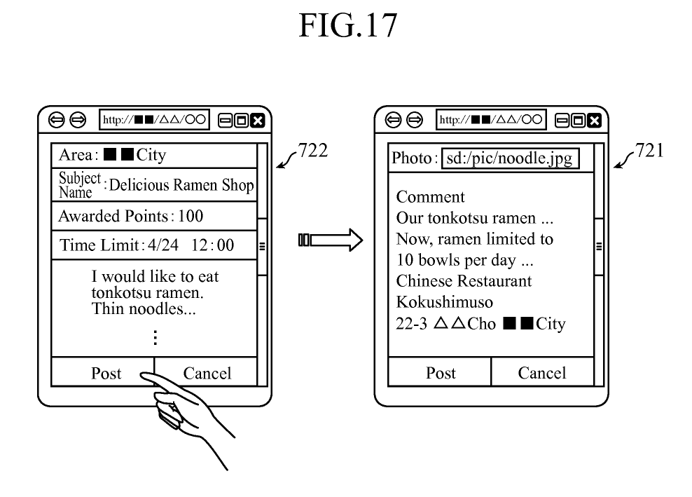

After that, the user of the shop terminal 7 refers to the request information display screen 722 as shown in FIG. 17, and inputs advertisement information about the user's own shop for the distribution request by using the information inputter 73. For example, in the example of FIG. 17, a “post” button and a “cancel” button are placed in a lowermost end portion of the request information display screen 722, and, when the “post” button is pressed down, the information inputter 73 notifies the display controller 71 that the “post” button is pressed down. When the “post” button is pressed down, the display controller 71 displays the post information setting screen 721 on the display 72.

The user of the shop terminal 7 refers to the shop information setting screen 721, and describes shop information corresponding to the distribution request by using the information inputter 73 (comment field). At that time, the post processor 74 generates post information from the information inputted thereto from the information inputter 73.

After that, when the user of the shop terminal 7 performs an operation of pressing down the “post” button in the shop information setting screen 721, the post processor transmits the post information to the information distribution server 2 via the shop side communicator 70.

In the information distribution server 2, the request information updater 27 updates the contents of the request information DB 28 by using the post information received by a server side communicator 30.

Next, the information retriever 22 retrieves post information corresponding to the user a's distribution request from the request information DB 28, like that in accordance with Embodiment 1. The post information selected by the information retriever 22 is outputted to the data generator 23. The data generator 23 generates distribution information by using the post information inputted thereto from the information retriever 22. The distribution information generated by the data generator 23 is transmitted to the vehicle-mounted device 1 which is the request source via the server side communicator 20. By doing in this way, advertisement information about a shop or the like can be presented in response to a request from the vehicle-mounted device 1.

As mentioned above, in accordance with this Embodiment 2, the server side communicator 20 communicates with the shop terminal 7 placed in a facility, such as a shop, and equipped with the post processor 74 that generates post information about the shop, and transmits the post information to the information distribution server 2, and, when distribution request information about a shop is received via the server side communicator 20, the information retriever 22 retrieves the post information about the shop terminal 7 from the information to be distributed stored in the request information DB 28, and the data generator 23 generates distribution information by using the post information of the shop terminal 7 which the information retriever 22 has retrieved and distributes the distribution information to the information presentation device which is the distribution request source via the server side communicator 20. By configuring the information presentation system in this way, from a facility side, such as a shop, advertisement information for promoting the use of the facility can be distributed actively at a low cost.

### Embodiment 3

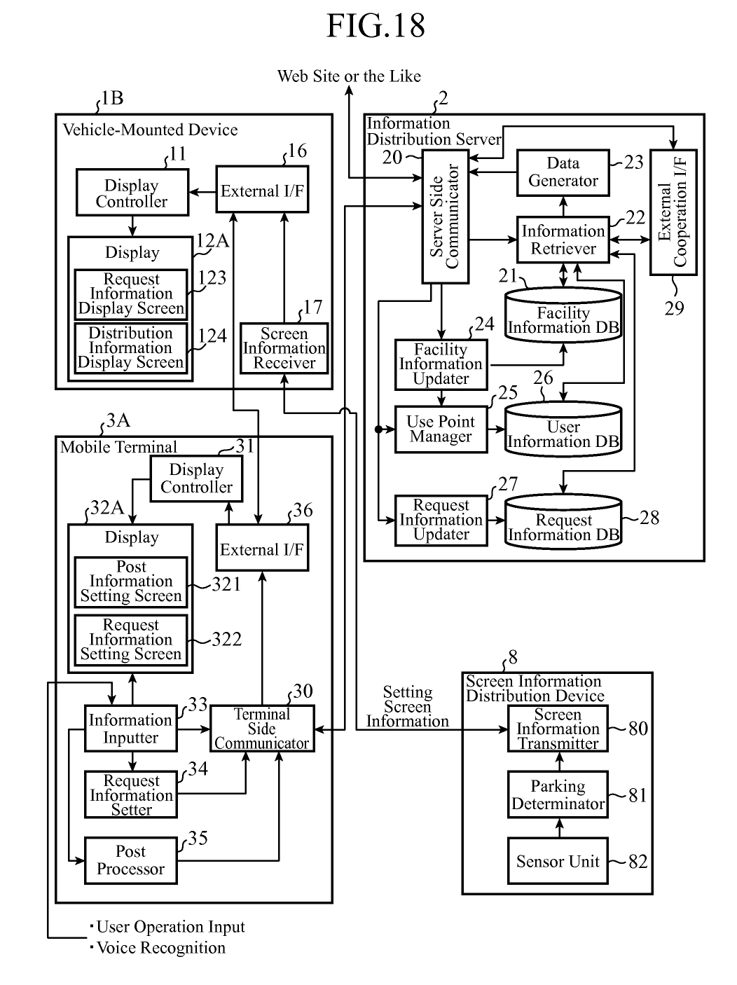

FIG. 18 is a block diagram showing the configuration of an information presentation system in accordance with Embodiment 3 of the present invention. As shown in FIG. 18, the information presentation system in accordance with Embodiment 3 is configured to include a vehicle-mounted device 1B, a mobile terminal 3A, an information distribution server 2, and a screen information distribution device 8.

The vehicle-mounted device 1B is configured to include a display controller 11, a display 12A, an external I/F 16, and a screen information receiver 17.

Further, the screen information distribution device 8 is placed in a parking lot owned by a facility, such as a shop, and distributes screen information for setting post information about this shop to the vehicle-mounted device 1B. The screen information distribution device is configured to include a screen information transmitter 80, a parking determinator 81, and a sensor unit 82.

In FIG. 18, the same components as those shown in FIG. 13 are designated by the same reference numerals, and the explanation of the components will be omitted hereafter.

The screen information receiver 17 is a receiver that receives the above-mentioned screen information from the screen information distribution device 8. For example, the screen information receiver is implemented by a communication unit that employs a radio communication method, such as Bluetooth (registered trademark, and this description will be omitted hereafter) or Wifi. The screen information which the screen information receiver 17 has received is sent to the mobile terminal 3A via the external I/Fs 16 and 36, and a display 32A of the mobile terminal 3A displays the screen information as a post information setting screen 321 under control by a display controller 31.

The screen information transmitter 80 is a communicator that distributes the above-mentioned screen information. For example, the screen information transmitter performs wireless communications, such as Bluetooth or Wifi, with the screen information receiver 17 of the vehicle-mounted device 1B.

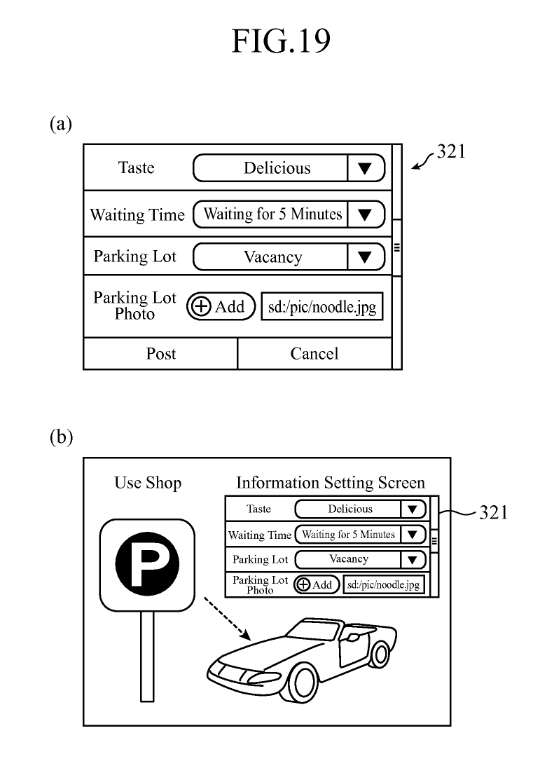

The screen information is information which defines the post information setting screen 321 which is a screen in which information items, as shown in FIG. 19(a), which are desired by the shop side having a parking lot to be posted, are described. XML, HTML, or JSON is assumed as the data format of the screen information. For example, because URL information can be transmitted so that the user is enabled to browse the screen information by using a browser of the mobile terminal 3A, no limit is imposed on the format of the transmission data.

The parking determinator 81 determines whether a vehicle has parked in the parking lot where the screen information distribution device 8 is placed on the basis of detection information detected by the sensor unit 82.

The sensor unit 82 detects that a vehicle has parked in the parking lot where the screen information distribution device 8 is placed. For example, as the sensor unit, there is provided a sensor that detects the outside shape of a vehicle by using a camera or a photosensor, or a sensor that detects the presence or absence of a vehicle by using a weight sensor. As an alternative, the sensor unit can be a parking information receiving unit that receives a notification, from the vehicle-mounted device 1B, indicating that the parking brake has been applied or the engine has been switched off in the vehicle.

Next, operations will be explained.

The parking determinator 81 of the screen information distribution device 8 determines whether a vehicle has parked in the parking lot on the basis of the detection information of the sensor unit 82. When the parking determinator 81 determines that a vehicle has parked in the parking lot, the screen information transmitter 80 transmits the screen information of the post information setting screen 321 about the shop having this parking lot to the screen information receiver 17 of the vehicle-mounted device 1B mounted in this vehicle, as shown in FIG. 19(b). The screen information which the screen information receiver 17 has received is sent to the mobile terminal 3A via the external I/Fs 16 and 36, and the display 32A of the mobile terminal 3A displays the screen information as the post information setting screen 321 under control by the display controller 31.

Next, the user of the mobile terminal 3A sets information about the shop (including a taste, a waiting time, the state of the parking lot, and a photo of the parking lot) by using the information inputter 33. After that, the post processor 35 generates post information about the shop, and transmits the post information to the information distribution server 2 via the terminal side communicator 30, like that in accordance with Embodiment 1. As a result, when a request for distribution of information about this shop is made, the information distribution server 2 can distribute the above-mentioned post information in response to this request.

Because an information item which is desired to be posted by a user can be specified by the facility side by doing in this way, by causing a company that manages a data communications service to prepare a basic template for data and also causing the facility side to prepare the above-mentioned screen information, information about the facility can be generated without spending time and effort.

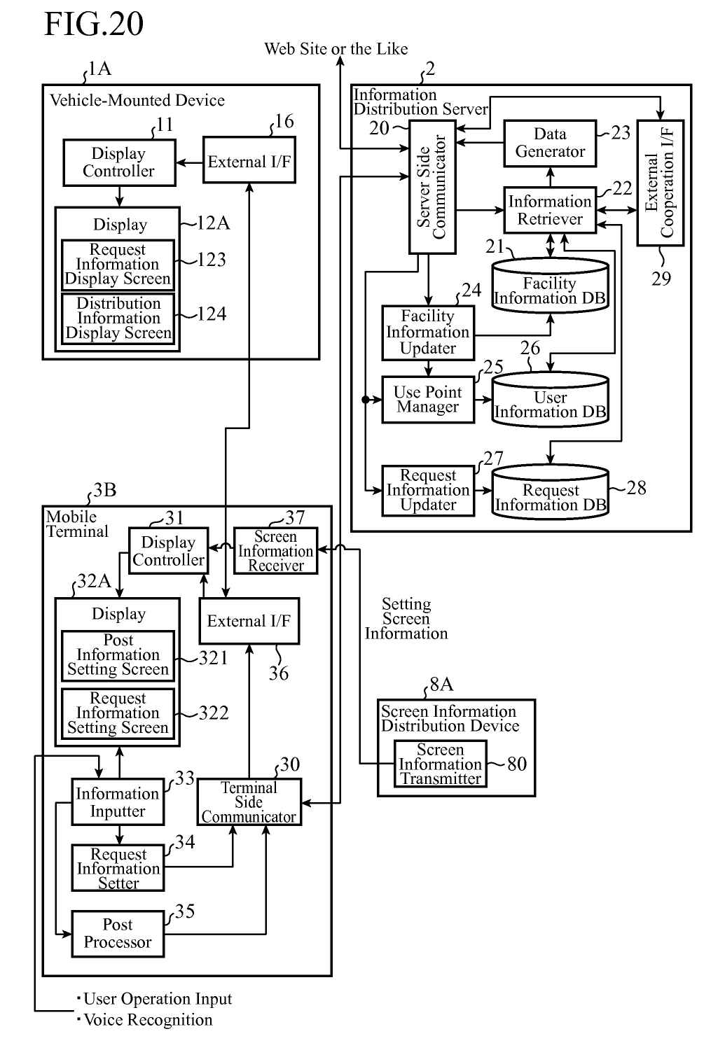

FIG. 20 is a diagram showing another example of the configuration of the information presentation system in accordance with Embodiment 3. The information presentation system shown in FIG. 20 is configured to include a vehicle-mounted device 1A, a mobile terminal 3B, an information distribution server 2, and a screen information distribution device 8A.

The mobile terminal 3B is provided with a terminal side communicator 30, a display controller 31, a display 32A, an information inputter 33, a request information setter 34, a post processor 35, an external I/F 36, and a screen information receiver 37.

Further, the screen information distribution device 8A is placed in a facility, such as a shop, and distributes screen information for setting post information about this shop to the vehicle-mounted device 1A. The screen information distribution device is configured to include a screen information transmitter 80A.

In FIG. 20, the same components as those shown in FIG. 13 are designated by the same reference numerals, and the explanation of the components will be omitted hereafter.

The screen information receiver 37 is a receiver that receives the above-mentioned screen information from the screen information distribution device 8A. For example, the screen information receiver is implemented by a communication unit that performs infrared ray communications, wireless communications, such as NFC (Near Field Communication), Bluetooth, or Wifi, or communications using QR code (registered trademark, and this description will be omitted hereafter).

The screen information transmitter 80A is a communicator that distributes the above-mentioned screen information. For example, the screen information transmitter performs infrared ray communications, wireless communications, such as NFC, Bluetooth, or Wifi, or communications using QR code with the screen information receiver 37 of the mobile terminal 3B. The screen information is, for example, information which defines a post information setting screen 321 which is a screen in which information items, as shown in FIG. 19(a), which are desired by the shop side to be posted, are described.

Next, operations will be explained.

When the user of the mobile terminal 3B causes the mobile terminal 3B and the screen information distribution device 8A to perform wireless communications with each other, the screen information transmitter 80A transmits screen information which defines the post information setting screen about this shop to the screen information receiver 37 of the mobile terminal 3B.

The display 32A of the mobile terminal 3B displays the screen information as the post information setting screen under control by the display controller 31.

Next, the user of the mobile terminal 3B sets information about the shop by using the information inputter 33. After that, the post processor 35 generates post information about the shop, and transmits the post information to the information distribution server 2 via the terminal side communicator 30, like that in accordance with Embodiment 1. As a result, when a request for distribution of information about this shop is made, the information distribution server 2 can distribute the above-mentioned post information in response to this request.

As mentioned above, in accordance with this Embodiment 3, the information presenter that is configured with the display controller 31A and the display 32A displays a post information setting screen defined by screen information received from the screen information distribution device 8 or 8A which is an external device, the information inputter 33 accepts an input of information based on the post information setting screen, and the post processor 35 generates post information to which the information inputted from the information inputter 33 and based on the post information setting screen is set, and transmits the post information to the information distribution server 2 via the terminal side communicator 30. Further, the screen information distribution device 8 or 8A is placed in a facility, such as a shop, and the post information setting screen is a screen in which information items which are desired by the facility side to be posted are described.

By configuring the information presentation system in this way, information items which are desired to be posted by a user can be specified by the facility side.

Although the case in which the moving object is a vehicle is shown in above-mentioned Embodiments 1 to 5, the moving object can be a person, a railroad, a ship, or an airplane.

While the present invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the information presentation device in accordance with the present invention can precisely acquire information having contents which the user desires, the information presentation device is suitable for, for example, a vehicle-mounted navigation device.

### EXPLANATIONS OF REFERENCE NUMERALS

1A, 1B vehicle-mounted device, 2 information distribution server, 3a, 3b, 3A, 3B mobile terminal, 4 to 6 Web server, 7 shop terminal, 8, 8A screen information distribution device, 10 device side communicator, 11, 11A, 31, 31A, 71 display controller, 12, 12A, 32, 32A, 72 display, 13, 33, 73 information inputter, 14, 34 request information setter, 15, 35, 74 post processor, 16, 36 external I/F, 17, 37 screen information receiver, 20 server side communicator, 21 facility information DB, 22 information retriever, 23 data generator, 24 facility information updater, 25 use point manager, 26 user information DB, 27 request information updater, 28 request information DB, 29 external cooperation I/F, 70 shop side communicator, 80, 80A screen information transmitter, 81 parking determinator, 82 sensor unit, 121, 321 post information setting screen, 122,122a, 122b, 322 request information setting screen, 123, 323, 323a, 323b, 323c, 722 request information display screen, 124, 124a, 124b, 324 distribution information display screen, and 721 shop information setting screen.

1. An information presentation device comprising:
a communicator communicating with an information distribution device that retrieves information corresponding to distribution request information from information to be distributed, and that performs a selection on the information retrieved thereby and distributes information selected thereby;
an information inputter inputting both contents of a request for information that is desired to be distributed, and points specifying both a reward for provision of information corresponding to this request contents and a description of the selection for said information distribution device;
a request information setter generating said distribution request information to which both said contents of the request for the information that is desired to be distributed and said points, which are inputted from said information inputter, are set, and transmitting said distribution request information to said information distribution device via said communicator; and
an information presenter receiving, via said communicator, the information which said information distribution device selects according to the description specified by said points, and presenting the information to a user.

2. The information presentation device according to claim 1, wherein said information inputter inputs points causing said information distribution device to retrieve information corresponding to said distribution request information from an external site, and said request information setter generates distribution request information to which said points inputted from said information inputter are set.

3. The information presentation device according to claim 2, wherein said information inputter inputs points specifying a number of external sites on each of which said information distribution device performs the retrieval for said information distribution device, and said request information setter generates distribution request information to which said points inputted from said, information inputter are set.

4. The information presentation device according to claim 2, wherein said information inputter inputs a specification of the external site on which said information distribution device performs the retrieval, and said request information setter generates distribution request information specifying, as a target for retrieval, the external site inputted from said information inputter.

5. The information presentation device according to claim 1, wherein said information inputter inputs, as the description of the selection, points specifying at least one of a selection according to an amount of information, a selection according to presence or absence of an image, and a selection according to a post time to said information distribution device, and said request information setter generates distribution request information to which said points inputted from said information inputter are set.

6. The information presentation device according to claim 1, wherein said information inputter inputs, as the contents of the request for the information that is desired to be distributed, an area or a facility name associated with the information that is desired to be distributed, a time limit for distribution, a number of posters for each of which points serving as a reward for provision of the information is provided, and a request item, and said request information setter generates distribution request information to which the contents of the request for the information that is desired to be distributed, which are inputted by said information inputter, are set.

7. The information presentation device according to claim 1, wherein said information presentation device comprises a post processor generating post information to which the information inputted from said information inputter is set, and transmitting the post information to said information distribution device via said communicator.

8. The information presentation device according to claim 7, wherein when said communicator receives call-for-post data in which priorities are assigned to distribution requests of said pieces of distribution request information, respectively, by said information distribution device, the priorities being assigned in descending order of points set to said pieces of distribution request information, said information presenter presents said distribution requests to the user in order of these priorities, said information inputter accepts an input of information corresponding to said distribution request, and said post processor generates the post information to which the information corresponding to said distribution request inputted from said information inputter is set and transmits the post information to said information distribution device via said communicator.

9. The information presentation device according to claim 7, wherein said information presenter displays a post information setting screen defined by screen information received from an external device, said information inputter accepts an input of information based on said post information setting screen, and said post processor generates the post information to which the information based on said post information setting screen, which is inputted from said information inputter, is set, and transmits the post information to said information distribution device via said communicator.

10. The information presentation device according to claim 9, wherein said external device is placed in a facility, and said post information setting screen is a one in which information items which are desired by said facility to be posted are described.

11. An information distribution device that retrieves information corresponding to distribution request information and distributes the information to an information presentation device, said information distribution device comprising:
a communicator communicating with said information presentation device;
an information database for distribution storing information to be distributed;
an information retriever, when said distribution request information to which both contents of a request for information that is desired to be distributed, and points specifying both a reward for provision of information corresponding to this request contents and a description of a selection for said information distribution device are received via said communicator, retrieving information corresponding to this distribution request information from the information to be distributed stored in said information database for distribution, and performs the selection on information which is a retrieval result according to the description specified by said points;
a data generator generating distribution information by using information selected by said information retriever, and distributing the distribution information to said information presentation device via said communicator;
a user information database storing payment and reception of points for each user; and
a point manager subtracting the points set to said distribution request information from points stored in said user information database and provided for a user of said information presentation device, and adding points to a user who has posted information presented by this information presentation device.

12. The information distribution device according to claim 11, wherein said information distribution device comprises an external interface communicating and connecting with an external site via said communicator, and wherein said information retriever retrieves the information corresponding to said distribution request information from said external site via said external interface according to a value of the points set to said distribution request information.

13. The information distribution device according to claim 11, wherein said data generator transmits summaries of a plurality of pieces of information corresponding to said distribution request information to said information presentation device via said communicator, and also, when a request for a detailed description of information selected from the summaries of said plurality of pieces of information is received, sends the detailed description of the information corresponding to this request, and said point manager provides the points set to said distribution request information for a poster of the information who has sent said detailed description.

14. The information distribution device according to claim 11, wherein said communicator communicates with a facility terminal provided with a post processor placed in a facility, and generating post information about said facility and transmitting the post information to said information distribution device, said information retriever retrieves said post information of said facility terminal from the information to be distributed stored in said information database for distribution when distribution request information about said facility is received via said communicator, and said data generator generates distribution information by using the post information of said facility terminal which said information retriever retrieves, and distributes the distribution information to said information presentation device which is a distribution request source via said communicator.

15. An information presentation method of communicating with an information distribution device that retrieves information corresponding to distribution request information from information to be distributed, and performs a selection on the retrieved information and distributes information selected, and presenting the information distributed from this information distribution device to an information presentation device, said information presentation method comprising:
inputting both contents of a request for information that is desired to be distributed, and points specifying both a reward for provision of information corresponding to this request contents and a description of the selection for said information distribution device;
generating said distribution request information to which both said contents of the request for the information that is desired to be distributed and said points inputted are set;
transmitting said distribution request information to said information distribution device, and receiving information distributed from said information distribution device in response to this distribution request information; and
presenting the information which is received from said information distribution device and which is selected according to the description specified by said points to said information presentation device.
